(19) United States
(12) Patent Application Publication
(10) Pub. No.: US 2026/0154497 A1
(43) Pub. Date: Jun. 4, 2026

(54) LLM-BASED LABELER DEVELOPMENT ENGINE

(71) Applicant: eBay Inc., San Jose, CA (US)

(72) Inventors: Luchao JIN, Houston, TX (US); Morteza MOAZAMI GOUDARZI, Cambridge, MA (US)

(21) Appl. No.: 18/968,026

(22) Filed: Dec. 4, 2024

(51) Int. Cl. G06F 40/20

(52) U.S. Cl. CPC G06F 40/20

(57) ABSTRACT

Methods, systems, and computer storage media for providing an LLM-based labeler development engine in a customer service management system are described. The LLM-based labeler development engine leverages ground-truth data (e.g., human-labeled data), example selection machine learning model, a few-shot learning LLM, and iterative labeling refinement operations to develop an LLM-based labeler. The labeler development engine uses the ground-truth data, the few-shot learning LLM and iterative refinement operations—including error analysis and automatic prompt correction to train the LLM-based labeler. The LLM-based labeler can be used to label a training dataset for training a machine learning model for the customer service email management system, the machine learning model supports categorizing incoming customer service emails. In this way, the LLM-based labeler operates as an intermediary labeler that is developed with a subset of data to facilitate labeling a training dataset for training the machine learning model of a customer service email management system.

### BACKGROUND

Users can engage with a customer service management system to streamline interactions between customers and service teams, improving both response times and satisfaction. A customer service management system is a suite of software tools designed to manage and optimize customer support workflows, including ticketing, live chat, self-service, and knowledge base management. These systems can integrate with various communication channels—such as email, phone, social media, and messaging platforms—to ensure seamless and efficient customer service. Customer service management systems can employ artificial intelligence (AI) and automation technologies to enhance service delivery. For instance, AI-driven chatbots can handle routine customer inquiries, while machine learning algorithms can prioritize tickets based on urgency and sentiment analysis. A customer service management system can be deployed using a combination of cloud-based solutions, APIs, and pre-built integrations with existing enterprise software to enhance operational efficiency, improve customer experience, and ensure consistent support across various channels.

### SUMMARY

Various aspects of the technology described herein are generally directed to systems, methods, and computer storage media for, among other things, providing an LLM-based labeler development engine in a customer service management system. The labeler development engine (i.e., LLM-supported labeler development) leverages ground-truth data (e.g., human-labeled data), example selection machine learning model, a few-shot learning LLM, and iterative labeling refinement operations to develop an LLM-based labeler. The labeler development engine uses the ground-truth data, the few-shot learning LLM and iterative refinement operations-including error analysis and automatic prompt correction to develop the LLM-based labeler. The LLM-based labeler can be used to label a training dataset for training a machine learning model for the customer service email management system, the machine learning model supports categorizing incoming customer service emails. In this way, the LLM-based labeler operates as an intermediary labeler that is developed with a subset of data to facilitate labeling a training dataset for training the machine learning model of a customer service email management system.

In operation, a first dataset associated with a training dataset is accessed. The first dataset comprises a first plurality of data items that are accurately labeled. An example selection machine learning model is used to identify few-shot learning data-a second dataset—from the first dataset. A few-shot learning LLM and a plurality of few-shot learning prompts are used to generate a first set of labels for a second plurality of data items in the few-shot learning data. An error analysis engine is used to generate a first error analysis input associated with the first set of labels based on evaluating the first set of labels for the second plurality of data items to corresponding accurate labels for second plurality of data items in the first dataset. Based on the first error analysis output, one or more updated few-shot learning prompts are generated using the plurality of few-shot learning prompts. The few-shot learning LLM and the updated few-shot learning prompts are used to generate a second set of labels for the second plurality of data items in the few-shot learning data. A second error analysis output for the second set of labels for the second plurality of data items in the few-shot learning data is generated. Based on the second error analysis output and the few-shot learning LLM, an LLM-based labeler is trained and deployed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an artificial intelligence system for providing LLM-based labeler development management, in accordance with aspects of the technology described herein;

FIGS. 2A and 2B are block diagram of an artificial intelligence system for providing LLM-based labeler development management, in accordance with aspects of the technology described herein;

FIG. 3 provides a first exemplary method of providing LLM-based labeler development management in an artificial intelligence system, in accordance with aspects of the technology described herein;

FIG. 4 provides a second exemplary method of providing LLM-based labeler development management in an artificial intelligence system, in accordance with aspects of the technology described herein;

FIG. 5 provides a third exemplary method of providing LLM-based labeler development management in an artificial intelligence system, in accordance with aspects of the technology described herein

FIG. 6 provides a block diagram of an exemplary artificial intelligence system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

A customer service management system can refer to a suite of tools designed to streamline and enhance interactions between businesses and their customers. It typically includes features like ticketing, live chat, email support, and knowledge base management to ensure timely and effective issue resolution. These systems often integrate with multiple communication channels, such as phone, social media, and messaging apps, providing a seamless experience across platforms. Advanced systems use AI-driven chatbots, automation, and analytics to improve efficiency, personalize service, and track key performance metrics. By centralizing customer interactions and providing actionable insights, these systems help businesses improve customer satisfaction and optimize support operations. A customer service management system can be deployed using a combination of cloud-based solutions, APIs, and pre-built integrations with existing enterprise software (e.g., an item listing system) to enhance operational efficiency, improve customer experience, and ensure consistent support across various channels.

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California. An item listing system may also provide generative-AI-supported applications (“generative AI applications”) that leverage generative AI models (e.g., Large Language Models-“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various task across different domains to provide improvement in automation, efficiency, and human-like interaction.

In this way, an item listing system provides can data that informs customer service interactions, and as such, can operate with a customer service management system to address any issues or questions that arise from those item listings. A customer service management system can be software solution designed to streamline and automate the handling of customer inquiries and support requests across various communication channels. The customer service management system centralizes customer interactions, allowing service teams to efficiently categorize, prioritize, and resolve issues, while tracking and managing each case through its lifecycle. With integrated tools such as ticketing systems, knowledge bases, and automation features like AI-driven chatbots, it enhances response times, reduces manual effort, and ensures consistent, high-quality customer service. The item listing system and customer service management system can be integrated to ensure seamless communication and efficient resolution of customer concerns.

Conventionally, customer service email management systems are not configured with a comprehensive logic and infrastructure to accurately understand and categorize the diverse and nuanced language used in customer emails. Natural Language Processing (NLP) models must handle varying tones, slang, and context-specific phrases, which can lead to frequent misclassifications and reduce the system's effectiveness. Achieving high accuracy requires continuous refinement of the model and large amounts of high-quality labeled data, adding to the complexity and cost of the system. Moreover, while developing a machine learning model to streamline email management is needed, it requires access to high-quality labeled data. Labeling data is often expensive, time-consuming, and prone to human bias, complicating the process and potentially impacting the model's effectiveness.

By way of context, current customer service email systems struggle with accurately processing the varied language used by customers. Emails often contain slang, informal tones, or context-specific phrases, leading to frequent misclassifications by traditional natural language processing (NLP) models. To maintain high accuracy in categorizing these emails, constant model refinement and vast amounts of high-quality labeled data are required. This creates significant overhead in terms of cost, time, and complexity, especially as the labeling process itself is resource-intensive, expensive, and susceptible to human biases.

Additionally, the inefficiencies in these systems mean that customer service agents spend considerable time addressing emails, many of which do not require any action, thereby increasing operational costs and slowing response times to more critical issues. As such, customer service agents spend a significant amount of time responding to emails, many of which require no action. This inefficiency results in higher operational costs and potential delays in addressing critical customer issues. As such, a more comprehensive customer service management system with an alternative basis for performing artificial intelligence operations—can improve computing operations and interfaces for providing LLM-based labeler development management with prompt interface security.

### Description of Technical Solution

At a high level, an LLM-based labeler development engine is provided as a machine learning tool designed to automatically generate accurate labels for data by leveraging large language models (LLMs) and few-shot learning techniques. It uses a combination of human-labeled ground-truth data, example selection algorithms, and iterative refinement processes such as error analysis and prompt optimization to improve the model's labeling accuracy over time. LLM-based labeler development engine enables efficient and scalable labeling of datasets, which are then used to train other machine learning models, particularly in applications like customer service management.

To address the limitations of conventional customer service email management systems in effectively understanding and categorizing diverse, nuanced customer emails, this technical solution focuses on developing an LLM-based labeler. The key objective is to enhance the accuracy and efficiency of categorizing customer emails by leveraging machine learning, large language models (LLMs), and an iterative development process, reducing both human error and operational inefficiencies. Current manual labeling methods are expensive, slow, and prone to error. Traditional machine learning models struggle to categorize emails due to variations in customer language (e.g., slang, informal tone, typos). This has led to incorrect routing of emails, causing delays in responding to customer issues.

The development of the LLM-based labeler begins with accessing a ground-truth dataset (e.g., 10,000 accurately labeled emails). These emails serve as the foundational data for training the labeler. From this first dataset, an LLM-based labeler development engine selects a subset of 500 emails using active learning and clustering techniques. This smaller, representative sample forms the few-shot learning dataset (i.e., second dataset). A few-shot learning LLM is then trained on this subset, generating initial labels for the emails based on prompts designed to categorize the data. Once the initial labels are produced, the LLM-based labeler development engine conducts error analysis by comparing the LLM-generated labels to the original accurate labels. This comparison highlights any misclassifications and calculates the error rate. Using the error analysis output, the LLM-based labeler development engine refines the few-shot learning prompts to improve the label accuracy. The process of error analysis and prompt refinement is repeated iteratively to further enhance the labeling precision. In particular, the error analysis and prompt refinement can be iteratively performed until the LLM-generated matches the ground-truth dataset (e.g., human-labeled training data set).

After several rounds of refinement, the LLM-based labeler development engine develops a highly accurate LLM-based labeler, which is then used to label a much larger training dataset of 100,000 new emails (e.g., historical sample data). The labeled data from this larger set is used to train a machine learning model (e.g., email management machine learning model) capable of categorizing and routing electronic communications (e.g., incoming emails). Once deployed, the model automates customer service actions by routing emails to the appropriate teams or generating automated responses, significantly reducing manual effort and improving response times.

By way of illustration, LLM-based labeler development engine may operate a real-world customer service email management system. The goal is to use the LLM-based labeler to efficiently categorize electronic communications into specific action categories, improving the customer service email management system's ability to respond to customer inquiries. For example, a large e-commerce company that receives thousands of customer service emails daily. These emails vary widely in tone, structure, and content. Common categories include: order status inquiries; refund requests; product complaints; technical support requests; and general inquiries.

Developing the LLM-based labeler can be explained through a series of steps exemplified by the LLM-based labeler development engine. Step 1: The company accesses a first dataset (e.g., ground truth data from a historical sample of data), which consists of 10,000 accurately labeled emails (i.e., a first plurality of data items) categorized by human agents, forming the ground-truth data for training.

Step 2: Using an example selection machine learning model, the LLM-based labeler development engine identifies a few-shot learning dataset (i.e., few-shot learning data) by selecting a subset of 500 emails from the ground-truth data, employing active learning and clustering techniques to ensure diverse language variations are represented.

Step 3: A few-shot learning LLM and a plurality of few-shot learning prompts are employed on a second plurality of data items in the few-shot learning data, utilizing the few-shot learning prompts to classify the emails into defined categories, such as labeling an email asking about order status as “Order Status Inquiry.”

Step 4: An error analysis engine then compares the generated labels (i.e., first set of labels for the second plurality of data items) against the accurate labels in the ground-truth dataset, identifying misclassifications and calculating error rates. Step 5: To enhance the LLM's performance, the LLM-based labeler development engine refines the prompts based on the errors found, emphasizing specific language cues for different categories. Step 6: This error analysis and prompt refinement process is repeated multiple times, leading to improved labeling accuracy as the LLM learns to recognize subtler variations in customer language.

Step 7: After several iterations, a highly accurate LLM-based labeler is developed, ready to categorize larger datasets. Step 8: The LLM-based labeler is then used to categorize a larger training dataset (e.g. 100,000 new emails) into predefined categories such as order status inquiries and refund requests. Step 9: This labeled dataset trains a machine learning model (i.e., email management machine learning model 152) to predict customer service actions for electronic communications, which is then deployed into the company's email management system.

Step 10: Once deployed, the machine learning model automatically classifies and prioritizes electronic communications, routing refund requests to the appropriate department, providing automated updates for order inquiries, forwarding product complaints to quality teams, and sending technical support requests to the tech support team. The hierarchical classification achieved by the LLM-based labeler reduces manual effort and enhances response times for customer inquiries.

Advantageously, the embodiments of the present technical solution support providing an LLM-based labeler development engine in an artificial intelligence system. The LLM-based labeler development engine enhances the accuracy and efficiency of the email management system by automating the labeling process with high precision, leveraging advanced machine learning techniques to minimize human bias and error in email categorization. By employing few-shot learning and iterative refinement, the engine can adapt to diverse language variations and evolving customer inquiries, ensuring a more robust labeling framework. This automation streamlines the workflow for customer service agents, enabling them to concentrate on higher-priority tasks and complex customer issues. Additionally, the LLM-based labeler development engine facilitates timely and contextually appropriate responses to customer inquiries, ultimately leading to improved customer satisfaction and operational efficiency within the email management system.

### Example Systems and Resources

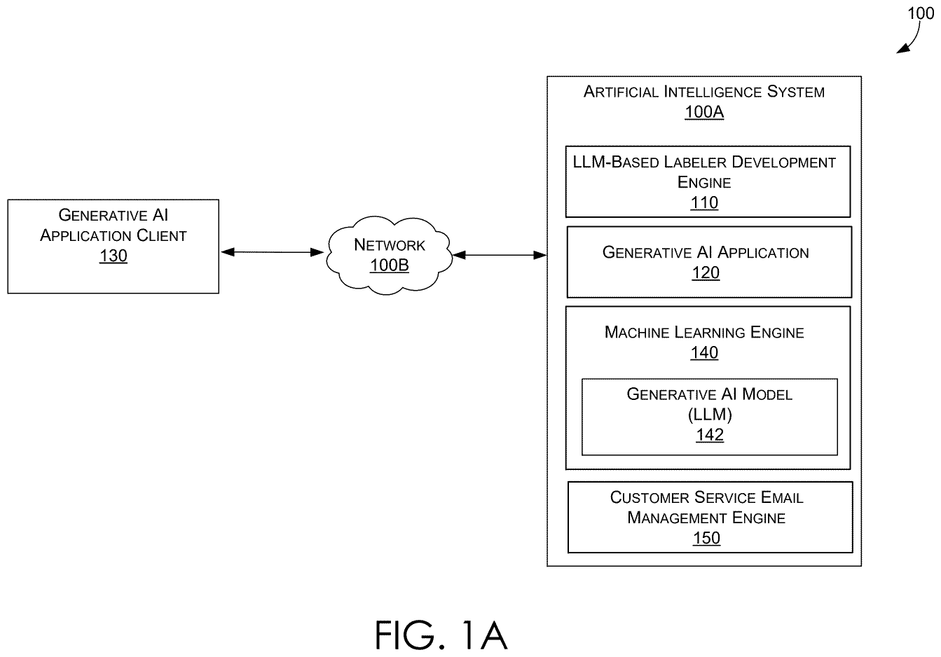

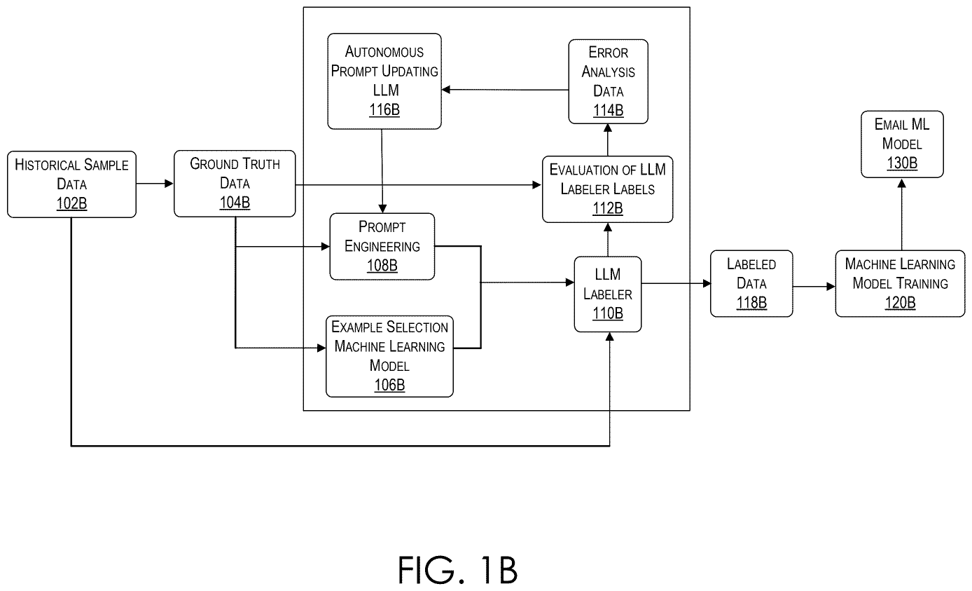

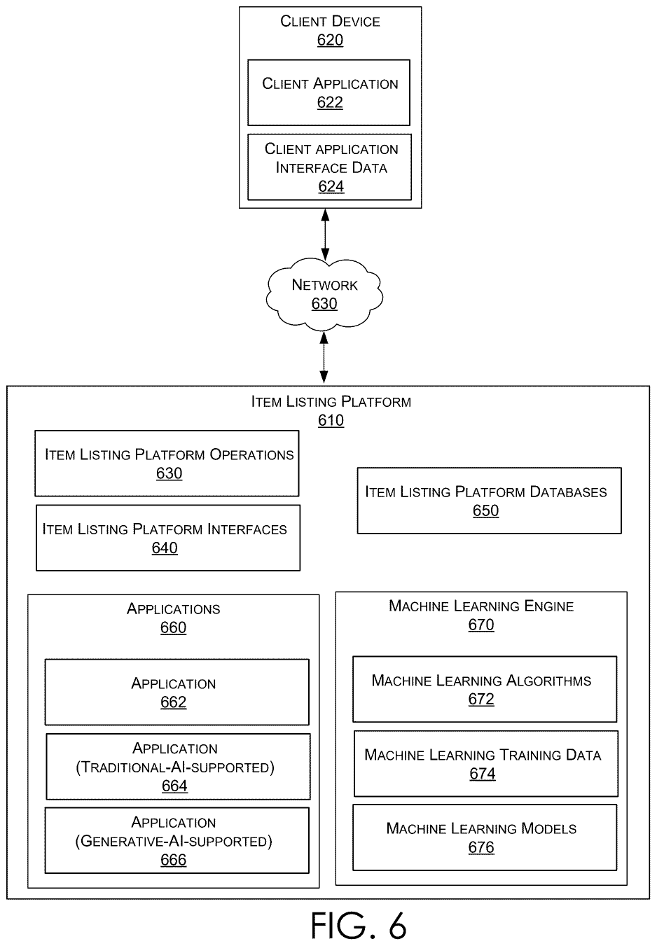

Aspects of the technical solution can be described by way of examples and with reference to FIGS. 1A-1B. FIG. 1A illustrates an customer service management system 100 that includes artificial intelligence system 100A, network 100B, LLM-based labeler development engine 110, generative AI application 120, generative AI application client 130, machine learning engine 140 with generative AL model (LLM) 142, and customer service email management engine 150. The customer service management system 100 corresponds to the customer service management system in item listing system 600 described below with reference to FIG. 6.

The customer service management system 100 provides a system (e.g., artificial intelligence “AI” system 100A) that includes an engine (e.g., LLM-based labeler development engine 110) for performing operations (e.g., security engine operations) discussed herein. The LLM-based labeler development engine 110 can operate with the generative AI application client 130 (e.g., a client device) that can access the customer service management system 100 to execute tasks using a generative AI application 120 associated with a corresponding generative AI model (e.g., an LLM 142). For example, a user-via the generative AI application client 130 (e.g., a prompt interface)—can communicate a request (e.g., a generative AI request having prompt data) to the generative AI application and the LLM to process the request. Based on the communicating the request, the AI system 100A can execute AI operations of the LLM-based labeler development engine 110—to ensure secure processing the request.

Customer service management engine 150 in this context leverages an advanced LLM-based labeler to automatically categorize and route incoming customer emails with high accuracy and efficiency. By using machine learning models trained on labeled datasets, the system can handle diverse language, slang, and varying tones, reducing misclassification and operational delays. With an iterative refinement process powered by few-shot learning and error analysis, the system continually improves its accuracy, ensuring customer inquiries—such as order status requests, refund claims, or technical support needs—are promptly addressed and directed to the appropriate departments. This automation reduces manual effort, enhances response times, and elevates overall customer satisfaction.

The LLM-based labeler development engine 110, customer service email management engine 150, and the generative AI application client provide resources (e.g., operations, interfaces, and data) that support providing the functionality described herein. The LLM-based labeler development engine 110 and the generative AI application client 130 can operate in a server-client relationship to provide LLM-based labeler development management. For example, a user can communicate a request from the generative AI application client 130 to execute a task via generative AI application 120 and LLM 142. Based on the request, the LLM-based labeler development engine 110 can perform operations to ensure secure processing of the request in the artificial intelligence system 100A.

The LLM-based labeler development engine 110 is designed to streamline the email categorization process by integrating ground-truth data, machine learning models, and a few-shot learning LLM into a cohesive system that iteratively refines and improves its performance. LLM-based labeler development engine 110 automates the labeling of data, particularly emails, to enhance efficiency and accuracy in customer service operations. The LLM-based labeler development engine 110 operations are structured into a series of interconnected tasks that facilitate the seamless flow of data and information throughout the labeling process.

At the operational level, LLM-based labeler development engine 110 initiates its functionality by accessing a primary dataset that consists of previously labeled emails, known as the ground-truth data. This dataset serves as the foundation for training and validating the model. The LLM-based labeler development engine 110 employs a selection mechanism, utilizing example selection algorithms that incorporate active learning and clustering techniques. This ensures the identification of a representative subset of data-referred to as few-shot learning data-comprised of emails that encompass a diverse range of categories and linguistic styles. This subset is critical for training the few-shot learning Large Language Model (LLM).

Once the few-shot learning data is established, the LLM-based labeler development engine 110 engages the LLM to generate initial labels. The LLM is prompted with hierarchical labeling structures that guide it in categorizing the emails into defined classes, such as “Order Status Inquiry” or “Technical Support Request.” The interface for these prompts is designed to include clear objectives, labeling formats, and examples that facilitate accurate labeling.

After the initial labeling, an error analysis component comes into play. An error analysis engine can be implemented as a large language model (LLM) (e.g., error analysis engine) that evaluates the accuracy of generated labels by comparing them to corresponding accurate labels from a ground truth dataset. This approach offers several significant benefits. First, the use of an LLM allows for automated and scalable analysis. The error analysis engine can process vast amounts of data quickly, enabling the rapid identification of discrepancies between generated labels and ground truth. Second, LLMs possess a nuanced understanding of language, which equips them to recognize subtleties in labeling that simpler algorithms might overlook. This contextual awareness enhances the accuracy of error detection and provides valuable insights into the nature of the mistakes. Additionally, employing an LLM facilitates adaptive learning. As the model identifies errors, it can adjust its prompts and labeling strategies, continuously improving its performance and reducing future inaccuracies. This iterative process creates a dynamic feedback loop, where the LLM can generate feedback and suggestions for refining prompts and labeling criteria based on its analysis. Moreover, utilizing an LLM can help mitigate biases present in human labeling by providing a more objective assessment of generated labels. This objectivity enhances the overall fairness and reliability of the labeling process.

In this way, an error analysis operation compares the LLM-generated labels against the accurate labels from the ground-truth dataset, identifying any misclassifications and calculating the error rates. This step enables assessing the model's performance and pinpointing areas needing improvement. In response to the findings from the error analysis, the LLM-based labeler development engine 110 integrates prompt engineering that allows for the dynamic updating of the labeling prompts. By analyzing the errors, the LLM-based labeler development engine 110 generates refined prompts that focus on specific linguistic cues relevant to the misclassified items, enhancing the LLM's understanding and labeling accuracy in subsequent iterations. The operational workflow is designed to be iterative, with cycles of error analysis and prompt refinement leading to continuous improvement. Each round of analysis and adjustment enables the LLM to learn from previous mistakes, resulting in progressively higher accuracy in labeling.

From a data perspective, the engine processes several types of information, including the ground-truth dataset, the few-shot learning subset, and the labels generated by the LLM. The labeling data is structured hierarchically, allowing the model to categorize emails into broad action categories, such as “Action Needed” or “No Action Needed,” followed by specific classifications like “Refund Request” or “Thank You.” Additionally, the LLM-based labeler development engine 110 produces a labeled training dataset, which serves as input for training a machine learning model. This model is subsequently deployed within the email management system, enabling it to automatically classify and route electronic communications (e.g., incoming emails) based on predicted actions. It is contemplated that electronic communications encompass, but are not limited to, email, instant messaging, text messaging (SMS), and any other digital messaging formats. Additionally, electronic communications include all forms of messages received through a customer service management system, enabling efficient handling of inquiries, support requests, and customer interactions.

In the context of the LLM-based labeler development engine used for processing customer service electronic communications, the terms predicting, classifying, and prioritizing refer to different aspects of handling electronic communications.

Predicting involves the machine learning model's capability to forecast the likely category or action associated with an email based on its content. For example, when an email is received, the model analyzes keywords and phrases to predict whether it pertains to a refund request, technical support, or general inquiry. This predictive step uses patterns learned from historical data to inform the next steps in processing the email.

Classifying refers to the process of assigning specific labels to the email once it has been predicted. After the model has predicted that an email is related to a refund request, it will classify it into a defined category, such as “Refund Request” or “Order Status Inquiry.” This classification is part of the hierarchical labeling process, where emails are organized into broader and narrower categories, enabling the system to understand the exact nature of the email and to manage it appropriately.

Prioritizing comes into play after classification, as the model determines the urgency of the email based on predefined criteria. For instance, if the email is classified as a “Refund Request,” the system might prioritize it over a “Thank You” email because it typically requires more immediate attention. This prioritization ensures that emails that need urgent action are handled first, streamlining the customer service workflow and improving response times.

Interfaces within the engine facilitate communication between various components, including the data access interface that retrieves the ground-truth dataset, the example selection interface that filters for few-shot learning data, and the labeling interface that allows the LLM to generate and refine labels. This interconnected framework ensures that the labeling process is efficient, accurate, and responsive to the needs of customer service operations, ultimately leading to improved response times and enhanced customer satisfaction.

With reference to FIG. 1B, FIG. 1B illustrates a schematic 100B associated with providing LLM-based labeler development engine in accordance with embodiments described herein. The development of the LLM-based labeler begins with historical sample data 102B. Historical sample data 102B can be associated with customer service management system in an e-commerce platform, where the historical sample data 102B includes records of customer interactions-such as emails, chats, calls, and support tickets-along with issue categories (e.g., order status, returns), timestamps for tracking response times, agent information with performance metrics, resolution statuses (resolved, pending, escalated), customer feedback ratings and comments, relevant product details, and customer profiles with demographics and purchase history. Historical sample data 102 can help improve service quality, identify common issues, and enhance the overall customer experience.

This historical sample data 102B can be used to create ground truth data 104B (i.e., a first plurality data items), a meticulously curated dataset comprising emails accurately categorized by human agents based on established criteria. Ground truth data 104B extracted from historical sample data refers to information that has been categorized or annotated by LLMs or individuals to support machine learning and analysis. Ground truth data 104B, in the context of email categorization, includes several essential elements that help in accurately identifying the appropriate category for each email. The primary component is the email's content, which provides the core information needed to classify the message, such as whether it's a customer inquiry about an order, a refund request, or a technical support issue. The subject line offers additional context by summarizing the email's purpose in a concise format. Information about the sender and recipient can also be crucial, as it helps to understand whether the communication is coming from a customer, a vendor, or an internal team member. Timestamps, indicating when the email was sent, provide another layer of context, potentially distinguishing urgent requests from routine follow-ups. Attachments or embedded media, such as documents or images, further enrich the content and can influence the classification by offering supplementary information relevant to the message. Together, these elements form a comprehensive dataset that serves as a reliable benchmark for training machine learning models to accurately predict email categories in future automated systems.

The next phase involves using an example selection machine learning model 106B to identify a subset of data known as few-shot learning data from the ground truth 104B. This selection process employs active learning and clustering techniques to ensure the chosen subset includes a diverse array of emails, representing various categories and language variations. Active learning focuses on selecting data points that are most likely to improve the model's performance when labeled, typically by identifying areas where the model is uncertain or prone to errors. By targeting these uncertain examples, the model can learn more efficiently, reducing the amount of training data needed to reach a high level of accuracy. Clustering techniques, on the other hand, group similar data points based on shared characteristics, such as language patterns or content type in emails. By organizing the ground truth data into clusters, the model can ensure that it selects examples from different clusters, representing a wide variety of categories, tones, and formats. This prevents overfitting to any single type of data and ensures that the model can generalize well across diverse scenarios. Together, active learning identifies high-impact examples where the model needs the most improvement, while clustering ensures that the selected examples represent a broad spectrum of the dataset. This combination allows the example selection model to pick the most valuable training data, optimizing the learning process for the LLM-based labeler. The selected few-shot learning data is essential for the training process, allowing the system to generate initial labels with high precision.

In prompt engineering 108B, the LLM-based labeler development engine utilizes a Few-Shot Learning Large Language Model (LLM) (e.g., via LLM labeler 110B) to generate a first set of labels for a second plurality of data items within the few-shot learning data. This is achieved by employing a variety of labeling prompts designed to guide the LLM in assigning appropriate labels based on a predefined hierarchical structure. Few-shot learning prompts for hierarchical email labeling are designed to guide the model through multiple levels of categorization, starting with broad categories and narrowing down to more specific subcategories.

Few-shot learning prompts can be structured templates designed to guide a model in tasks such as classification or labeling by providing clear instructions and examples. These prompts typically begin with an objective, which outlines the main goal of the task, clarifying what the model is expected to achieve. For instance, the objective might state, “Classify emails into predefined categories based on their content.” Next, the prompts include a labeling structure that describes how the labeling should be organized hierarchically. This component provides a framework that helps the model understand the relationships between different categories and subcategories, defining broad categories such as “Action Needed” or “No Action Needed” and detailing the specific labels that fall under each category.

The example format specifies how examples should be presented to the model, setting the standard for the input it will receive, including the structure and types of data to be labeled. For example, it might include a statement like, “An email asking for a refund should be categorized as ‘Refund Request.’” In addition, the prompts incorporate few-shot examples, which are specific instances that illustrate how the model should classify data. These examples help the model learn from limited instances, demonstrating how to apply the labeling structure to real-world scenarios. For example, a few-shot example might state, “Email 1: ‘I'd like to return this item’->Label: ‘Refund Request.’”

Finally, the prompts conclude with a prompt for new data, directing the model to apply what it has learned from the previous components to unseen data. This section might include a statement like, “Now classify the following email based on the established criteria,” followed by the text of the new email to be labeled. By integrating these elements, few-shot learning prompts effectively teach the model how to categorize data items with minimal examples while maintaining a structured approach that facilitates accurate classification.

These prompts help the model progressively refine its understanding of email content, teaching it to classify each email based on hierarchical levels. For instance, the model may start by determining whether an email falls under “Action Needed” or “No Action Needed” and then move to more specific labels like “Refund Request” or “Thank You.”

The structure of these prompts allows the model to handle nuanced distinctions, with each level providing more detailed categorization. Few-shot examples are provided to help the model learn how to make decisions at each level, such as labeling an email asking for a refund as “Action Needed” or categorizing a technical issue email under “Technical Support Request.” This structured approach helps the model navigate complex classifications, ensuring accurate and hierarchical labeling of emails. These prompts outline objectives, labeling structures, example formats, and specific few-shot examples to ensure the LLM comprehensively understands the labeling requirements.

Following the generation of initial labels, the LLM-based labeler development engine conducts an evaluation of LLM labeler labels 112B. Here, an error analysis engine 176 (e.g., an LLM-powered error analysis engine) assesses the accuracy of the generated labels by comparing them to the corresponding accurate labels from the ground truth data. This evaluation produces a first error analysis output, identifying misclassifications and calculating error rates. For instance, it may reveal that refund requests are incorrectly categorized as product complaints. Armed with insights from the error analysis data 114B, the LLM-based labeler development engine refines its labeling approach through autonomous prompt updating LLM 116B.

Autonomous prompt-updating LLM is an advanced model designed to automatically refine and optimize the prompts used in a machine learning system, particularly for tasks like few-shot learning and hierarchical labeling. This LLM monitors the performance of the LLM labeler by analyzing errors or misclassifications that occur during the labeling process. Based on this error analysis, it autonomously modifies the prompts by identifying areas where the model struggles (e.g., confusion between similar categories) and generating updated or more precise prompts to improve classification accuracy.

For example, if the model frequently mislabels emails requesting refunds as general inquiries, the autonomous prompt-updating LLM might update the prompt to emphasize keywords like “refund,” “return,” or “money back,” thereby guiding the model more effectively. This refinement process happens iteratively, ensuring the prompts evolve alongside the model's learning, ultimately improving performance without requiring human intervention. In essence, the autonomous prompt-updating LLM dynamically adjusts instructions for the model, enhancing both accuracy and adaptability in complex classification tasks.

This iterative process involves generating updated few-shot learning prompts based on the error analysis output. Updated few-shot learning prompts for hierarchical email labeling are constructed to guide the model through a multi-tiered classification process. These prompts leverage structured cues to enable the model to categorize emails progressively, moving from broad categories to more granular subcategories. The hierarchical design of the prompts ensures that each decision point in the classification tree is handled step-by-step, allowing the model to capture nuanced distinctions in the email content. Few-shot examples are included at each hierarchical level to instruct the model on how to correctly classify diverse email scenarios, providing sample inputs that illustrate the expected category for similar types of messages. This method allows the model to handle complex and layered classification tasks, facilitating accurate labeling even in cases where email content might contain overlapping or ambiguous elements. By emphasizing critical language cues and specific terminology relevant to various customer inquiries, the updated prompts enhance the LLM's labeling accuracy.

Using the refined prompts, the few-shot learning LLM generates a second set of labels for the few-shot learning data. The LLM-based labeler development engine again conducts an error analysis to produce a second error analysis output, allowing for further evaluation of the model's performance. Based on the results of this second evaluation, the LLM-based labeler development engine continues to refine the labeling process, ensuring that the LLM is continually improving. The process of error analysis and prompt refinement is conducted iteratively to enhance labeling precision further. Specifically, this iterative approach involves continuously analyzing the errors identified in the initial outputs and refining the prompts used to guide the language model (LLM). This cycle is repeated until the LLM-generated results closely align with the ground-truth dataset, such as human-labeled training data. Through this meticulous process, the accuracy and reliability of the model's outputs are progressively improved, ensuring that they meet or exceed established standards for precision in labeling.

With a labeling process in place, the LLM-based labeler development engine iteratively supports train an LLM-based labeler 110. This newly developed labeler is capable of processing larger datasets (e.g., historical sample data 102B), effectively categorizing email inquiries into predefined categories such as order status inquiries, refund requests, and technical support requests. Ultimately, this labeled dataset (i.e., label data 118B) is utilized to train (i.e., machine learning model training 120B) a comprehensive machine learning model (e.g., email ML 130B) designed to predict customer service actions for incoming emails.

Once trained, the machine learning model is deployed into a customer service email management system, where it automatically classifies and routes incoming emails according to the predicted customer service actions. This hierarchical classification system streamlines operations, ensuring timely responses and enhancing overall customer satisfaction. Through this meticulous process, the LLM-based labeler development engine demonstrates its capability to enhance the efficiency and accuracy of email management within customer service environments.

In this way, the LLM-based labeler development engine integrates advanced machine learning techniques to automate the labeling of incoming emails, thereby enhancing the efficiency of customer service email management systems. The process begins with a labeling machine learning model that has been rigorously trained using a labeled dataset consisting of diverse customer email inquiries. This training equips the model with the ability to categorize emails based on predefined hierarchical structures.

By way of example, when an email is received, the machine learning model initiates its classification process. The first step is to assign the email to a primary hierarchical level, where it categorizes the email into one of two broad categories: Action Needed or No Action Needed. This binary classification is critical for prioritizing how customer service agents address incoming inquiries.

For emails identified as requiring action, the model then evaluates the content further and categorizes them into specific actionable subcategories, representing the second hierarchical level. Examples of emails that fall into the Action Needed category include:

Refund Request: Emails where customers request a refund for a purchase; Technical Support Request: Emails seeking assistance with product-related issues; Order Status Inquiry: Emails asking for updates on the delivery status of a purchase; Product Complaint: Emails reporting problems with received products or services.

On the other hand, for emails categorized as No Action Needed, the machine learning model also sorts them into distinct subcategories, ensuring that the system efficiently manages and responds to these inquiries. Examples of emails classified as No Action Needed include: Thank You Acknowledgment: Emails that express gratitude but do not solicit further action, such as “Thank you for your prompt response.”; Automatic Responses: Out-of-office emails or auto-responders that do not require human intervention, such as “I am currently out of the office and will respond to your email upon my return.”; Profanity: Emails containing inappropriate language without any request for action, which can be flagged for review but do not necessitate a response; Advertisements: Promotional emails or spam that do not require any engagement from customer service and Pop-box Notifications: Informational messages regarding system notifications or reminders that do not require action from the customer service team.

The ability to categorize emails into these defined hierarchical levels allows the email management system to streamline workflows effectively. By segregating emails that need immediate attention from those that do not, customer service agents can prioritize their responses, focusing on resolving critical issues while managing less urgent inquiries in a more efficient manner. Moreover, the underlying LLM labeler continuously improves its accuracy through iterative refinement processes, incorporating feedback from error analysis and self-prompt updating. This ensures that the labeling system remains adaptive to evolving customer language patterns and expectations, ultimately leading to enhanced customer satisfaction and operational efficiency within the organization.

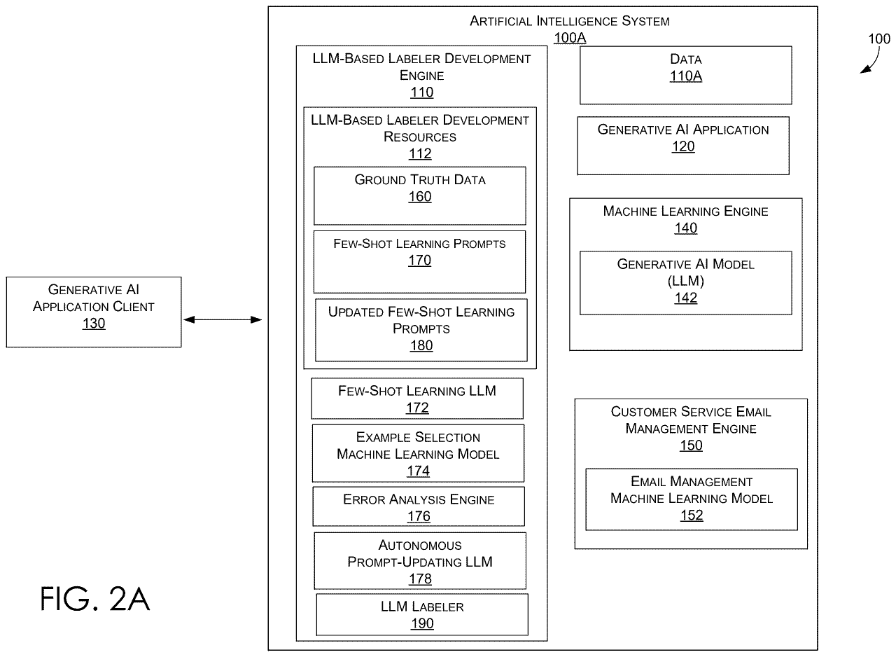

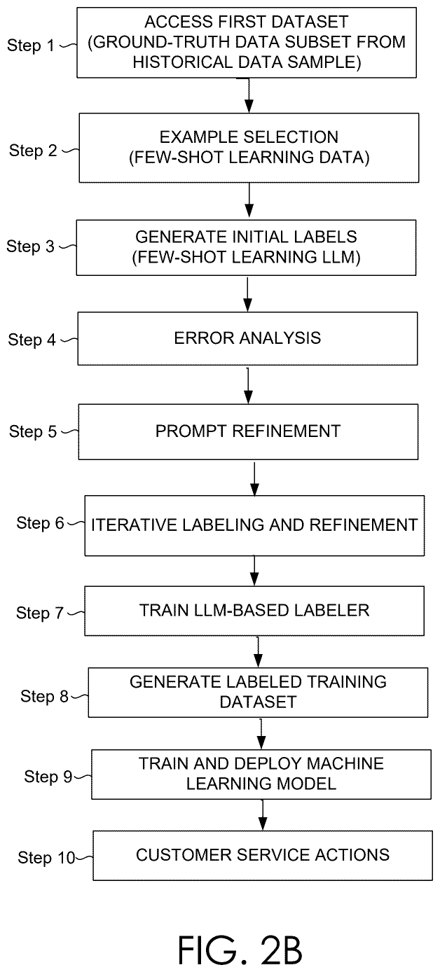

Aspects of the technical solution can be described by way of examples and with reference to FIGS. 2A and 2B. FIG. 2A and FIG. 2B are block diagrams of an exemplary technical solution environment, based on example environments described with reference to FIGS. 6A, 6B, 7 and 8 for use in implementing embodiments of the technical solution are shown. Generally the technical solution environment includes a technical solution system suitable for providing the example customer service management system 100 in which methods of the present disclosure may be employed. In particular, FIG. 2A shows a high level architecture of the customer service management system 100 in accordance with implementations of the present disclosure. Among other engines, managers, generators, selectors, or components not shown (collectively referred to herein as “components”), the customer service management system 100 of FIG. 2 corresponds to FIGS. 1A and 1B.

With reference to FIG. 2A, FIG. 2A illustrates artificial intelligence system 100A including LLM-based labeler development engine 110; data 110A; LLM-based labeler development resources 112; generative AI application 120; generative AI application client 130; machine learning engine 140 including generative AI model (LLM) 142; customer service email management engine 150 including email management machine learning model 152; ground truth data 160, few-shot learning prompts 170, few-shot learning LLM 172, example selection machine learning models 174, error analysis engine 176, self-prompt updating LLM 178, and LLM-labeler 190.

Functionality associated with the LLM-based labeler development engine 110 is provided using LLM-based labeler resources 112 including operations, interfaces, and data. By way of illustration, operations commence with data ingestion, where a primary dataset (e.g., data 110A) containing accurately labeled emails (e.g., ground truth data 160) is collected and preprocessed for labeling. Ground truth data 160 serves as the foundation for training the LLM-based labeler (i.e., LLM labeler). Ground truth data 160 provides accurately labeled data items, which will be used for comparison and validation.

Example data (e.g., few-shot learning data) can be identified using an example selection machine learning model (e.g., example selection machine learning model 174). This example selection machine learning model is responsible for identifying a subset of data (i.e., few-shot learning data) from the labeled dataset (i.e., ground-truth data). Example selection machine learning model 174 employs active learning and clustering techniques to ensure that the data is representative and diverse enough to support hierarchical categorization.

The core functionality involves utilizing engines, language models and machine learning models (e.g., few-show learning LLM 172, example selection machine learning model 174, error analysis engine 176, self-prompt updating LLM 178, and LLM labeler 180) select to automatically generate labels for emails based on hierarchical labeling structures defined in few-shot learning prompts. The few-shot learning LLM 172 generates initial labels for the few-shot learning data by applying a series of prompts. These prompts guide the model to assign labels based on a predefined hierarchical structure.

Following the automatic labeling, an error analysis engine (e.g., error analysis engine 176) evaluates the generated labels against the accurate labels from the ground-truth data 160. This analysis identifies misclassifications and calculates error rates, providing valuable insights into the model's performance. Based on the results, a prompt engineering LLM (e.g., autonomous prompt-updating LLM) refines the labeling prompts to improve the LLM's accuracy in future iterations. In particular, using the error analysis output, the few-shot learning prompts are automatically updated by a prompt engineering LLM. These refined prompts are then used to re-label the data in subsequent iterations, ensuring continuous improvement in label accuracy. This iterative cycle of error analysis and prompt refinement enhances the labeling process and the LLM's overall performance.

The interfaces associated with the engine include a user interface (UI), providing a web or application platform where annotators can easily view, edit, and approve labels. Additionally, API access allows developers to programmatically interact with the labeling engine, facilitating integration with other systems. Visualization tools, such as dashboards, are employed to monitor labeling progress, model performance, and feedback metrics, while a configuration panel enables adjustments to labeling criteria, model parameters, and review processes.

In terms of data components, the LLM-based labeler development engine 110 processes several key elements. The initial raw data consists of emails requiring annotation, while labeled data includes the annotations generated by the LLM and human reviewers. This labeled data is critical for training and evaluating the model, ensuring ongoing enhancements in accuracy and performance. Metadata is also collected to provide context about the labeling process, encompassing timestamps, annotator identities, and revision histories. Together, this framework facilitates efficient and scalable labeling processes, significantly enhancing the quality of labeled data for machine learning applications, ultimately improving response times and customer satisfaction in customer service operations.

The LLM-based labeler reduces the time and effort required to label data, thus lowering costs associated with manual labeling. The iterative process ensures continuous refinement of the labels, leading to a more accurate machine learning model for email categorization. Few-shot learning enables the system to generalize from a small dataset, reducing the need for vast amounts of labeled data upfront. By automating much of the labeling process and relying on error analysis-driven improvements, the system minimizes human biases that can otherwise affect labeling accuracy.

With reference to FIG. 2B, FIG. 2B illustrates a schematic 200B associated with providing LLM-based labeler development engine in accordance with embodiments described herein. By way of example, Step 1: Access First Dataset (Ground-Truth Data)—the company has an existing dataset of 10,000 labeled emails that have been accurately categorized by human agents. These categories include the common ones listed above and form the ground-truth data. This dataset will serve as the basis for training the LLM-based labeler. Step 2: Example Selection (Few-Shot Learning Data)—using the example selection machine learning model, the system selects a subset of 500 emails from the ground-truth dataset. This subset is chosen using active learning and clustering techniques to ensure that it includes examples from each major category, representing different types of language variations (e.g., slang, formal tone, technical jargon). This subset is known as the few-shot learning data. Step 3: Generate Initial Labels (Few-Shot Learning LLM)—a few-shot learning LLM is then trained using this subset. The model is prompted with a hierarchical structure to classify the emails. For example, the labeling prompt may include: Objective: Label each email based on the following categories; Labeling Structure: Provide hierarchical labels, starting from broad categories (e.g., “Inquiry”) down to specific actions (e.g., “Order Status”). Example Format: “An email asking when an order will arrive should be labeled as ‘Order Status Inquiry’. Few-Shot Examples: Provide examples for each category, such as emails about refunds, technical issues, or product complaints. The LLM generates labels for these 500 emails based on the prompts, categorizing them into the same categories as the ground-truth data.

Step 4: Error Analysis—the error analysis engine compares the generated labels with the corresponding accurate labels from the ground-truth data. It identifies misclassifications such as: Emails asking for refunds incorrectly labeled as “Product Complaints.” Emails inquiring about technical issues misclassified as “General Inquiries.” Based on this analysis, the error rate is calculated, and the types of misclassifications are highlighted. Step 5: Prompt Refinement—to improve the LLM's performance, the LLM-based labeler development engine uses an automatic prompt engineering LLM. This LLM refines the few-shot learning prompts based on the errors identified: For refund requests, the updated prompt emphasizes language cues like “money back,” “refund,” or “return policy.” For technical support, the new prompt includes terms like “not working,” “troubleshoot,” and “error.” These updated prompts are then used to regenerate the labels for the same 500 emails.

Step 6: Iterative Labeling and Refinement—the error analysis and prompt refinement process is repeated multiple times, each time improving the LLM's labeling accuracy. For example, after the second round of error analysis, the misclassification rate drops significantly as the LLM learns to distinguish between more subtle variations in customer language. Step 7: train the LLM-Based Labeler-after several iterations, the LLM-based labeler development engine has developed a highly accurate LLM-based labeler that can categorize emails based on the learned hierarchical structure. The model is now ready to label larger datasets.

Step 8: Label the Training Dataset—the LLM-based labeler is used to label a larger training dataset containing 100,000 new emails. These emails are now accurately categorized into the predefined categories: order status inquiries; refund requests; product complaints; technical support requests; and general inquiries. Step 9: Train and Deploy Machine Learning Model—this newly labeled dataset is used to train a machine learning model designed to predict customer service actions for incoming emails. The model is deployed into the company's email management system, allowing it to automatically classify and route emails based on the predicted customer service actions.

Step 10: Customer Service Actions-once deployed, the system automatically categorizes and prioritizes incoming emails into specific actions. For example, an incoming email is received containing a request for a refund due to a defective product. The email is processed by the LLM-based labeler development engine. First, the content of the email is analyzed, and a prediction is made that it is related to a refund request based on the keywords and phrases identified. Following this, the email is classified into the specific category of “Refund Request” as part of the hierarchical labeling structure. Finally, the urgency of the email is evaluated, and it is prioritized as “High Priority” because it requires immediate attention for customer satisfaction. Consequently, the email is routed to the refund department for prompt handling, ensuring that the customer's request is addressed swiftly. In this way, Refund Requests are routed to the refund department for immediate handling; Order Status Inquiries are responded to with automated status updates; Product Complaints are forwarded to the product quality team; and Technical Support Requests are sent to the technical support team. The LLM-based labeler development engine's hierarchical classification ensures that emails are properly routed, reducing manual effort and improving response times.

### Example Methods

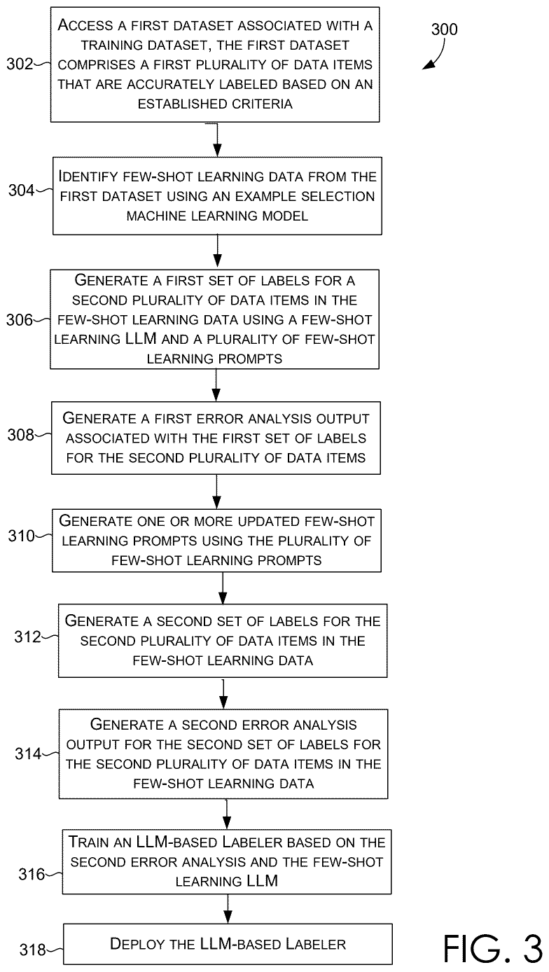

With reference to FIGS. 3, 4, and 5 flow diagrams that illustrate methods for providing an LLM-based labeler development engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer implemented method) in an artificial intelligence system (e.g., computerized system or computer system).

Turning to FIG. 3, a flow diagram is provided that illustrates a method 300 for providing an LLM-based labeler development engine in an artificial intelligence system. At block 302, the LLM-based labeler development engine accesses a first dataset associated with a training dataset. The first dataset comprises a first plurality of data items that are accurately labeled based on an established criteria. At block 304, using an example selection machine learning model, the LLM-based labeler development engine accesses identifies few-shot learning data from the first dataset. At block 306, using a few-shot learning LLM and a plurality of few-shot learning prompts, the LLM-based labeler development engine generates a first set of labels for a second plurality of data items in the few-shot learning data. At block 308, using an error analysis engine, the LLM-based labeler development engine generates a first error analysis output associated with the first set of labels for the second plurality data items based on evaluating the first set of labels for the second plurality of data items to corresponding accurate labels for the second plurality of data items in the first data. At block 310, based on the error analysis output, the LLM-based labeler development engine generates one or more updated few-shot learning prompts based on the plurality of few-shot learning prompts. At block 312, the LLM-based labeler development engine generates a second set of labels for the second plurality of data items in the few-shot learning data. At block 314, the LLM-based labeler development engine generates second error analysis output for the second set of labels of the second plurality of data items in the few-shot learning data. At block 316, the LLM-based labeler development engine trains an LLM-based labeler based on the second error analysis and the few-shot learning LLM. At block 318, the LLM-based labeler development engine deploys the LLM-based labeler.

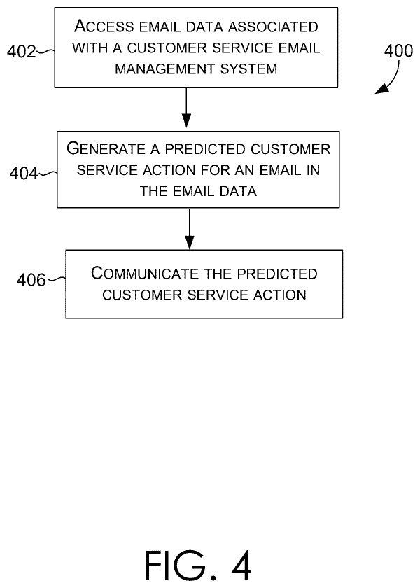

Turning to FIG. 4, a flow diagram is provided that illustrates a method 400 for providing an LLM-based labeler development engine in an artificial intelligence system. At block 402, the customer service email management engine accesses email data associated with a customer service email management system. At block 404, the customer service email management engine accesses generates a predicted customer service action for an email in the email data using a machine learning model associated with an LLM-based labeler. The LLM-based labeler is trained using an LLM-based labeler development engine that iteratively develops the LLM-based labeler based on a plurality of iterative refinement operations. At block 406, the customer service email management engine accesses communicates the predicted customer service action.

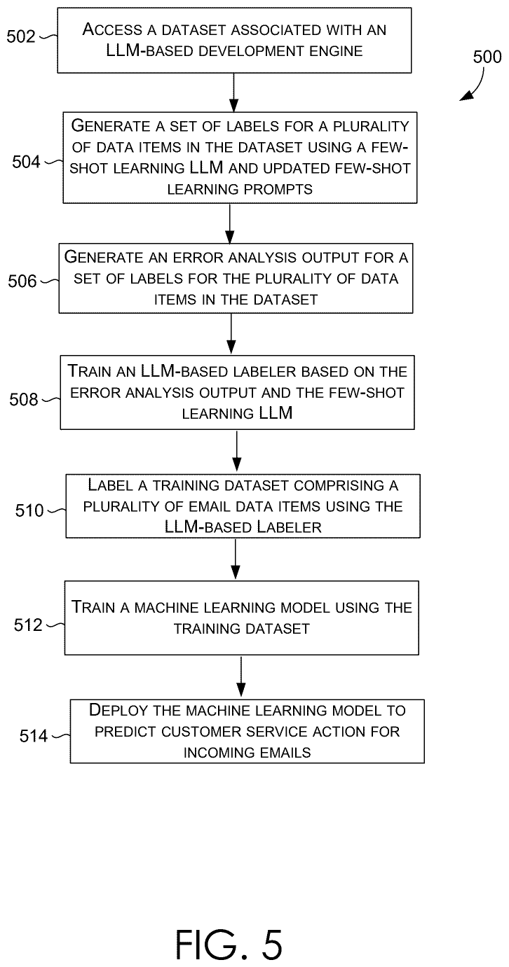

Turning to FIG. 5, a flow diagram is provided that illustrates a method 500 for providing an LLM-based labeler development engine in an artificial intelligence system. At block 502, the LLM-based labeler development engine accesses a dataset associated with an LLM-based labeler development engine. At block 504, the LLM-based labeler development engine generates a set of labels for a plurality of data items in the dataset using a few-shot learning LLM and updated few-shot learning prompts. At block 506, the LLM-based labeler development engine generates an error analysis output for the set of labels for the plurality of data items in the dataset. At block 508, the LLM-based labeler development engine trains an LLM-based labeler based on the error analysis output and the few-shot learning LLM. At block 510, the LLM-based labeler development engine labels a training dataset comprising a plurality of email data items using the LLM-based labeler. At block 512, the LLM-based labeler development engine trains a machine learning model using the training dataset. At block 514, the LLM-based labeler development engine deploys the machine learning model to predict customer service actions for electronic communications.

### Technical Improvement

Embodiments of the present invention have been described with reference to several inventive features (e.g., operations, systems, engines, and components) associated with an customer service management system. Inventive features described include: operations, interfaces, data structures, and arrangements of computing resources associated with providing the functionality described herein relative with reference to an LLM-based labeler development engine associated with an artificial intelligence system.

Embodiments of the present invention relate to the field of computing, and more particularly to an artificial intelligence system. The following described exemplary embodiments provide a system, method, and program product to, among other things, execute generative AI security engine operations that provide LLM-based labeler development management. Therefore, the present embodiments improve the technical field of artificial intelligence technology and item listing platform technology by providing more effective machine learning development and application. For example, the LLM-based labeler development engine offers automated and scalable labeling that significantly reduces manual effort and time in data categorization. It leverages the advanced language understanding capabilities of LLMs to handle complex and nuanced content, ensuring high labeling accuracy. The LLM-based labeler development engine iterative refinement process-through prompt engineering and error analysis-continuously improves model performance, minimizing misclassifications over time. It also supports hierarchical labeling structures, making it adaptable for various industries and use cases. The technical solution addresses conventional item listing platforms' lack of integration of LLM-based labeler development engine based on improving artificial intelligence technology by improving machine learning development and application in the artificial intelligence system.

Functionality of the embodiments of the present invention have further been described, by way of an implementation and anecdotal examples—to demonstrate that the operations for providing LLM-based labeler development management using an LLM-based labeler development engine in an customer service management system as a solution to a specific problem in artificial intelligence technology to improve computing operations in artificial intelligence systems. Overall, these improvements result in less CPU computation, smaller memory requirements, and increased flexibility in artificial intelligence systems when compared to previous conventional artificial intelligence system operations performed for similar functionality.

### Additional Support for Detailed Description of the Invention Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services-including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 630) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing system's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 120 supports the process of building, training, and fine-tuning machine learning models. Machine learning training data 120 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

Item listing system 600 provides item listing system data that informs customer service interactions, and as such, can operate with a customer service management system (e.g., customer service management system 100 in FIG. 1) to address any issues or questions that arise from those item listings. A customer service management system can be software solution designed to streamline and automate the handling of customer inquiries and support requests across various communication channels. The customer service management system centralizes customer interactions, allowing service teams to efficiently categorize, prioritize, and resolve issues, while tracking and managing each case through its lifecycle. With integrated tools such as ticketing systems, knowledge bases, and automation features like AI-driven chatbots, it enhances response times, reduces manual effort, and ensures consistent, high-quality customer service. The item listing system and customer service management system can be integrated to ensure seamless communication and efficient resolution of customer concerns.

### Example Distributed Computing System Environment

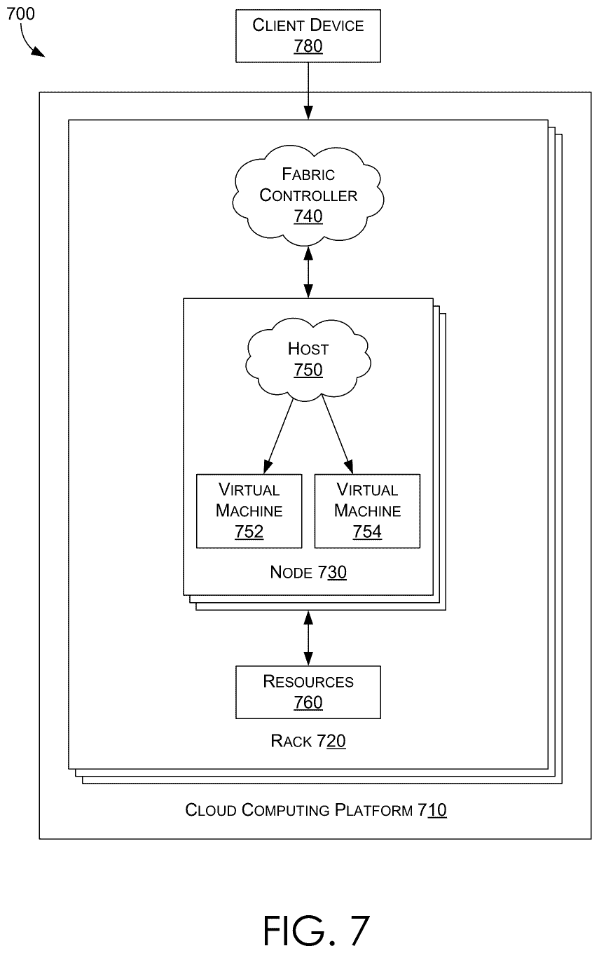

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

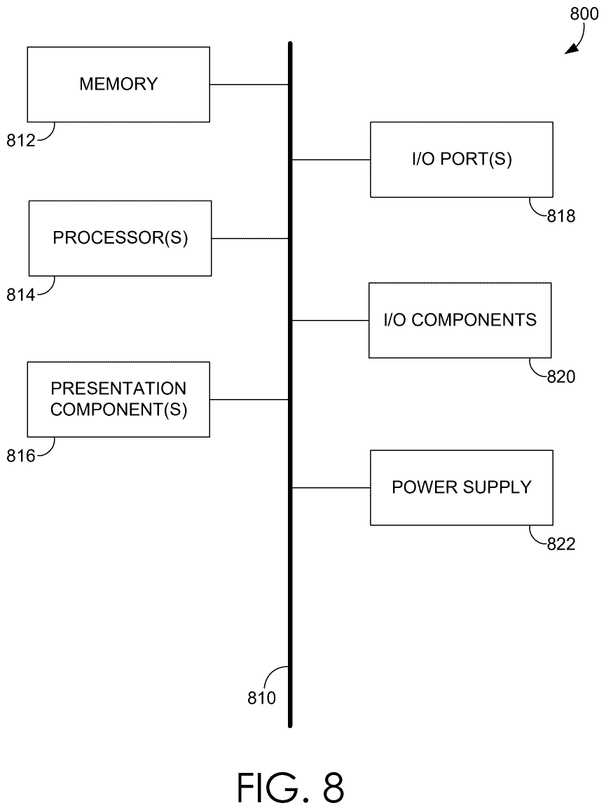

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a first dataset associated with a training dataset, wherein the first dataset comprises a first plurality of data items that are accurately labeled based on an established criteria;
using an example selection machine learning model, identifying few-shot learning data from the first dataset, the few-shot learning data is a second dataset comprising a second plurality of data items;
using a few-shot learning Large Language Model (LLM) and a plurality of few-shot learning prompts, generating a first set of labels for the second plurality of data items in the few-shot learning data;
using an error analysis engine, generating a first error analysis output associated with the first set of labels for the second plurality data items based on evaluating the first set of labels for the second plurality of data items to corresponding accurate labels for the second plurality of data items in the first dataset;
based on the first error analysis output, generating one or more updated few-shot learning prompts using the plurality of few-shot learning prompts;
using the few-shot learning LLM and the updated few-shot learning prompts, generating a second set of labels for the second plurality of data items in the few-shot learning data;
generating a second error analysis output for the second set of labels for the second plurality of data items in the few-shot learning data;
based on the second error analysis output and the few-shot learning LLM, training an LLM-based labeler; and
deploying the LLM-based labeler.

2. The system of claim 1, wherein the example selection machine learning model selects the few-shot learning data based on both an active learning technique and a clustering technique.

3. The system of claim 1, wherein the few-shot learning data is identified to support a hierarchical categorization of data items in the few-shot learning data.

4. The system of claim 1, wherein the plurality of few-shot learning prompts comprises hierarchical labeling prompts that are designed to guide the few-shot learning LLM to assign labels to data items based on a predefined hierarchical structure.

5. The system of claim 1, wherein the plurality of few-shot learning prompts are associated with prompt templates that include the following: an objective, a labeling structure, an example format, few-shot examples, and a prompt for new data.

6. The system of claim 1, further comprising a prompt engineering LLM that supports using the error analysis output to automatically update few-shot learning prompts for prompt-based learning using the updated few-shot learning prompts.

7. The system of claim 1, wherein the example selection machine learning model, the few-shot learning LLM and the error analysis engine are part of a labeler development engine that iteratively develops the LLM-based labeler based on a plurality of iterative refinement operations.

8. The system of claim 1, the operations further comprising:
using the LLM-based labeler, labeling the training dataset comprising a plurality email data items;
training a machine learning model with the training dataset, wherein the machine learning model is associated with a customer service email management system; and
deploying the machine learning model to predict customer service actions for electronic communications.

9. The system of claim 1, wherein the customer service actions are associated with a hierarchical classification of customer service actions.

10. One or more computer-storage media having computer-executable instructions embodied thereon that, when executed by a computing system having a processor and memory, cause the processor to perform operations, the operations comprising:
accessing email data associated with a customer service email management system;
using a machine learning model associated with a Large Language Model (LLM)-based labeler, generating a predicted customer service action for an email in the email data, wherein the LLM-based labeler is trained using an LLM-based labeler development engine that iteratively develops the LLM-based labeler based on a plurality of iterative refinement operations; and
communicating the predicted customer service action.

11. The media of claim 10, wherein the LLM-based labeler development engine comprises an example selection machine learning model and a few-shot learning LLM.

12. The media of claim 10, wherein the LLM-based labeler development engine comprises an error analysis engine and an autonomous prompt-updating engine.

13. The media of claim 10, the operations further comprising: based on the predicted customer service action, routing the email to a predefined email management service associated with the predicted customer service action.

14. The media of claim 10, the operations further comprising generating an automated response to a sender associated with the email based on the predicted customer service action.

15. A computer-implemented method, the method comprising:
accessing a dataset associated with an LLM-based labeler development engine;
using a few-shot learning LLM and few-shot learning prompts of the LLM-based labeler development engine, generating a set of labels for a plurality of data items in the dataset;
generating an error analysis output for the set of labels for the plurality of data items in the dataset;
based on the error analysis output and the few-shot learning LLM, training an LLM-based labeler;
using the LLM-based labeler, labeling a training dataset comprising a plurality email data items;
training a machine learning model using the labeled training dataset, wherein the machine learning model is associated with a customer service email management system; and
deploying the machine learning model in the customer service email management system to predict customer service actions for electronic communications at the customer service email management system.

16. The computer-implemented method of claim 15, wherein the dataset is few-shot learning data identified using an example selection machine learning model, wherein the example selection machine learning model selects the few-shot learning data based on both an active learning technique and a clustering technique, wherein the few-shot learning data is identified to support a hierarchical categorization of data items in the few-shot learning data.

17. The computer-implemented method of claim 15, wherein the few-shot learning LLM supports a plurality of few-shot learning prompts comprising hierarchical labeling prompts that are designed to guide the few-shot learning LLM to assign labels to data items based on a predefined hierarchical structure, wherein the plurality of few-shot learning prompts are associated with prompt templates that include the following: an objective, a labeling structure, an example format, few-shot examples, and a prompt for new data.

18. The computer-implemented method of claim 15, wherein the updated few-shot learning prompts are accessed via a prompt engineering LLM that supports using a previous error analysis output to automatically update few-shot learning prompts for prompt-based learning using the updated few-shot learning prompts.

19. The computer-implemented method of claim 15, wherein the few-shot learning prompts are updated few-shot learning prompts that are accessed via a prompt engineering LLM that supports using a previous error analysis output to automatically update few-shot learning prompts for prompt-based learning using the updated few-shot learning prompts.

20. The computer-implemented method of claim 15, wherein the updated few-shot learning prompts are accessed via a prompt engineering LLM that supports using a previous error analysis output to automatically update few-shot learning prompts for prompt-based learning using the updated few-shot learning prompts.
